(19) United States
(12) Patent Application Publication
(10) Pub. No.: US 2017/0104683 A1
(43) Pub. Date: Apr. 13, 2017

(54) DYNAMICALLY SEGMENTING TRAFFIC FOR A/B TESTING IN A DISTRIBUTED COMPUTING ENVIRONMENT

(71) Applicant: SAMSUNG SDS AMERICA, INC., Ridgefield Park, NJ (US)

(72) Inventor: Kannan PARTHASARATHY, Palo Alto, CA (US)

(73) Assignee: SAMSUNG SDS AMERICA, INC., Ridgefield Park, NJ (US)

(21) Appl. No.: 15/290,433

(22) Filed: Oct. 11, 2016

Related U.S. Application Data
(60) Provisional application No. 62/238,913, filed on Oct. 8, 2015.

(51) Int. Cl. H04L 12/851; H04L 12/743

(52) U.S. Cl. CPC H04L 47/2441; H04L 45/7453

(57) ABSTRACT

An approach for dynamically segmenting traffic in a distributed computing environment is provided. The approach initiates a model allocation table by allocating traffic to one or more models. The approach retrieves a model identifier from a traffic segmentation table. The approach retrieves a current traffic allocation and a desired traffic allocation for the model identifier. The approach indicates a slot of the model identifier as free in the traffic segmentation table. The approach determines a number of slots to allocate to the model. The approach assigns one or more free slots to the model.

### BACKGROUND

This disclosure relates generally to a distributed computing environment, and more particularly, to dynamically segmenting traffic for A/B Testing in a distributed computing environment.

Distributed computing environments are used in data analytics platforms that process an ever-increasing amount of data and in decision making engines that need to respond to requests in near-real time. With the widespread adoption of digital technologies in a myriad of domains (e.g. online retail, news, entertainment, social media, etc.), distributed computing environments are used to scale the large transaction rates necessary to keep pace with the rapid traffic growth.

An emerging trend is to provide personalized experiences to end customers, in which the interaction with end customers is driven by an underlying model. For example, when an online retailer presents the content and layout of the web page to a customer in a manner to optimize a business objective (e.g. amount of money spent by the customer at the online retail site), an underlying set of rules or a model provides the best layout and content for that customer in a manner that optimizes the objective.

In order to provide personalized experiences to end customers, a platform for real-time decision making uses a model to make predictions of a possible outcome and can prescribe the best action to take from a set of possible actions. Typically, sophisticated machine learning techniques build the parameters of these models by processing training data collected from a live system. As user behavior and other environmental factors evolve, the current models need to evolve as well in order to provide the best possible experience to the end customers and to maximize profits for the business.

A common approach to minimize risk when deploying a new model to a production system is to conduct A/B testing. A/B testing may be implemented by selecting a small percentage of users(e.g. 5%) and applying model B for all interactions to these selected users, in which model A is applied for all interactions to the remaining users (i.e. 95%). The label “A” refers to the incumbent or existing model in the production system, and “B” refers to the contending or new model. All transaction data, along with any data useful to calculate a business metric, are collected during A/B testing. Depending on the specific case, the A/B testing period can vary from a few hours, several days, or even several weeks. At the end of the A/B testing period, a previously agreed upon business metric is computed for each of the two models, in which the scores computed for each model may be normalized. Based on the collected data and computed business metrics, a decision is made as to whether or not model B is better than model A. If model B is better than model A, model A is removed from the production system and model B is applied to all users. Alternatively, if model A is better than model B, model B is removed from the production system and model A is applied to all users.

When conducting A/B testing, user traffic has to be split across the two models in the desired percentage(e.g. 95% of the traffic uses model A and 5% of the traffic uses model B). Typically, it is highly desirable or even required to use the same model for all transactions associated with a given user. However, in order for the results to be statistically significant, the selection of users for a given model should be random (i.e. a randomly selected set of users should be assigned to model B and the remaining users should continue to use model A)

In a distributed computing environment, the processing load is distributed across the nodes in the cluster. One common technique to distribute traffic to the compute nodes is to use a specialized traffic director (e.g. load balancer) to split incoming traffic and distribute the traffic to the compute nodes. To utilize A/B testing with this technique, the set of compute nodes must be partitioned into two groups (e.g. the first group uses model A and the second group uses model B). However, this approach is difficult to build and maintain. For example, the traffic director will need to be aware of which set of nodes is using model A and which set of nodes is using model B. Dynamically changing the binding of models to users (e.g. when a new model is created) will require re-partitioning of the cluster and reconfiguration of the traffic director.

### SUMMARY

In some exemplary embodiments a dynamically segmenting traffic method, implemented by one or more processors, includes: initiating a model allocation table by allocating traffic to one or more models; retrieving a model identifier from a traffic segmentation table; retrieving a current traffic allocation and a desired traffic allocation for the model identifier; indicating a slot of the model identifier as free in the traffic segmentation table; determining a number of slots to allocate to the model; and assigning one or more free slots to the model.

In other exemplary embodiments, a traffic segmenting apparatus includes: at least one memory operable to store program instructions; at least one processor operable to read the stored program instructions; and according to the stored program instructions, the at least one processor is configured to be operated as: a driver configured to initiate a model allocation table by allocating traffic to one or more models, to retrieve a current traffic allocation and a desired traffic allocation for the model identifier, to indicate a slot of the model identifier as free in the traffic segmentation table, to determine a number of slots to allocate to the model, and to assign one or more free slots to the model; and one or more compute nodes configured to retrieve a model identifier from a traffic segmentation table.

In yet other embodiments, a non-transitory computer readable storage medium, implemented by one or more processors, storing traffic segmentation program for causing a computer to function as: a driver configured to initiate a model allocation table by allocating traffic to one or more models, to retrieve a current traffic allocation and a desired traffic allocation for the model identifier, to indicate a slot of the model identifier as free in the traffic segmentation table, to determine a number of slots to allocate to the model, and to assign one or more free slots to the model; and one or more compute nodes configured to retrieve a model identifier from a traffic segmentation table.

### BRIEF DESCRIPTION OF DRAWINGS

FIG. 1 is a functional block diagram illustrating a distributed computing environment, according to an exemplary embodiment.

FIG. 2 is an example illustrating a traffic segmentation table, according to an exemplary embodiment.

FIG. 3 is an example illustrating a traffic segmentation table with three models, according to an exemplary embodiment.

FIG. 4 is a flowchart illustrating operational steps of traffic segmentation program (such as the traffic segmentation program of FIG. 1) to determine a model allocation for a request message, according to an exemplary embodiment.

FIG. 5 is an example illustrating the distribution of samples across hash values (slot indexes) for different hash functions, according to an exemplary embodiment.

FIG. 6 is an example illustrating a comparison of cumulative error on a sample data set for three specific hash functions, according to an exemplary embodiment.

FIG. 7 is a flowchart illustrating the operational steps of a traffic segmentation program (such as the one described in FIG. 1) to update the Traffic Segmentation Table

FIG. 8 is an example illustrating the initiation of a Model Allocation Table, according to an exemplary embodiment.

FIG. 9 is an example illustrating the initial states of the Traffic Segmentation and Model Allocation tables, according to an exemplary embodiment.

FIG. 10 is an example illustrating the states of the Traffic Segmentation and Model Allocation Tables, according to an exemplary embodiment.

FIG. 11 is an example illustrating the states of the Traffic Segmentation and Model Allocation Tables, according to an exemplary embodiment.

FIG. 12 is a flowchart illustrating the operational steps of a traffic segmentation program (such as the one described in FIG. 1) to update the Traffic Segmentation Table, according to an exemplary embodiment.

FIG. 13 is an example illustrating the states of the Traffic Segmentation and Model Allocation Tables, according to an exemplary embodiment.

FIG. 14 is an example illustrating the states of the Traffic Segmentation and Model Allocation Tables, according to an exemplary embodiment.

### DETAILED DESCRIPTION

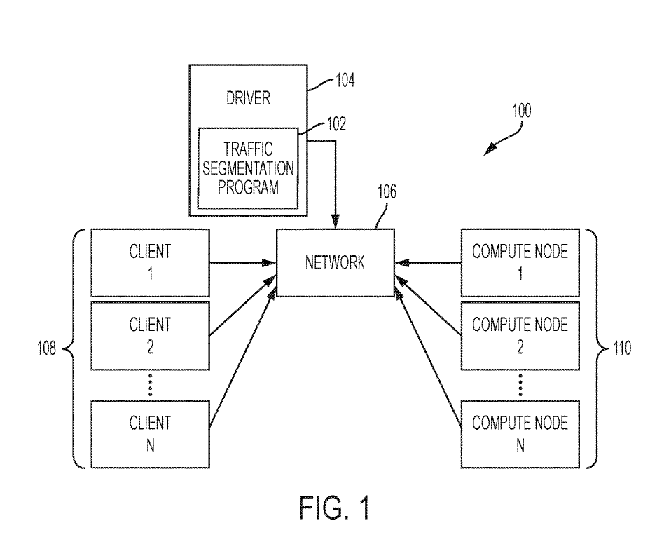

Exemplary embodiments of the present invention relates generally to a distributed computing environment, and more particularly, to dynamically segmenting traffic for A/B Testing in a distributed computing environment. Exemplary embodiments recognize that dynamically changing the binding of models to users requires re-partitioning of the cluster and reconfiguration of the traffic director. However, exemplary embodiments for dynamically segmenting traffic for A/B testing in a distributed computing environment are described below with references to FIGS. 1-14.

Implementation of such exemplary embodiments may take a variety of forms, and exemplary implementation details are discussed subsequently with reference to the Figures.

FIG. 1 is a functional block diagram illustrating a distributed computing environment 100, according to an exemplary embodiment. FIG. 1 provides only an illustration of one implementation and does not imply any limitations with regard to the environments in which different embodiments may be implemented. Many modifications of the depicted environment may be made by those skilled in the art without departing from the scope of the invention as recited by the claims. In some embodiments, the distributed computing environment 100 includes a network 106, a driver 104, which operates traffic segmentation program 102, one or more clients 108, and one or more compute nodes 110. Embodiments are applicable to distributed computing environment 100 having a set of homogenous compute nodes.

Network 106 interconnects driver 104, one or more clients 108, and one or more compute nodes 110. In general, network 106 can be any combination of connections and protocols capable of supporting communication between driver 104, one or more clients 108, one or more compute nodes 110, and traffic segmentation program 102. In some exemplary embodiments, network 106 can be a message bus. In an exemplary embodiment, traffic segmentation program 102 implements network 106 using a cluster of compute nodes that can scale to handle larger message rates. Network 106 can include wire cables, wireless communication links, fiber optic cables, routers, switches, firewalls, or any combination that can include wired, wireless, or fiber optic connections known by those skilled in the art.

In some exemplary embodiments, driver 104 hosts traffic segmentation program 102, in accordance with exemplary embodiments of the present invention. In one exemplary embodiment, driver 104 can be any programmable electronic device or computing system capable of receiving and sending data, via network 106, and performing computer-readable program instructions known by those skilled in the art. In some exemplary embodiments, driver 104 can include a data storage repository (not shown) for storing data including, but not limited to, state information for all entities associated with an environment, transaction data, traffic segmentation table information, hash values, model allocation table information, and various models or policies. Data storage repository can be any programmable electronic device or computing system capable of receiving, storing, and sending files and data, and performing computer readable program instructions capable of communicating with driver 104 and one or more compute nodes 110, via network 106. In an exemplary embodiment, driver 104 can be a coordinator or orchestrator for the one or more compute nodes 110. In other exemplary embodiments, traffic segmentation program 102 resides locally on one or more compute nodes 110, in which traffic segmentation program 102 and driver 104 are connected via network 106.

In some exemplary embodiments, driver 104 includes traffic segmentation program 102 to dynamically segment traffic in a distributed computing environment. For example, traffic segmentation program 102, utilizing driver 104, initiates a model allocation table by allocating traffic to one or more models; retrieves a current traffic allocation and a desired traffic allocation for the model identifier; indicates a slot of the model identifier as free in the traffic segmentation table; determines a number of slots to allocate to the model; and assigns one or more free slots to the model. In another example, traffic segmentation program 102, utilizing one or more compute nodes 110, retrieves a model identifier from a traffic segmentation table.

In some exemplary embodiments, traffic segmentation program 102 operates on a central server, such as driver 104, and can be utilized by one or more clients 108 and by one or more compute nodes 110 via a mobile application downloaded from the central server or a third-party application store, and executed on the one or more clients 108 and one or more compute nodes 110. In some exemplary embodiments, traffic segmentation program 102, utilizing network 106, can route messages of one or more clients 108 to a specific compute node using a partitioning scheme. In other exemplary embodiments, traffic segmentation program 102 routes all messages associated with a user (i.e. an entity) to a particular compute node. In yet other exemplary embodiments, traffic segmentation program 102, utilizing driver 104, coordinates the processing at the compute nodes. In an exemplary embodiment, driver 104, operating traffic segmentation program 102, runs on a specific compute node and starts tasks that are distributed across one or more compute nodes 110.

In some exemplary embodiments, one or more compute nodes 110 can provide a service that can be accessed by one or more clients 108. In an exemplary embodiment, traffic from a specific user of a client 108 can be processed by any of one or more compute nodes 110.

In some exemplary embodiments, a client 108 is an agent to driver 104 and can be for example, a desktop computer, a laptop computer, a smart phone, or any other electronic device or computing system, known by those skilled in the art, capable of communicating with the driver 104 through the network 106. For example, client 108 may be a laptop computer capable of accessing traffic segmentation program 102 through a network, such as network 106 and providing requests for actions and rewards. In other exemplary embodiments, client 108 can be any suitable types of mobile devices capable of running mobile applications or a mobile operating system. In yet another exemplary embodiment, client 108 can be an intermediary, such as a website, between an end user and traffic segmentation program 102.

In some exemplary embodiments, a compute node 110 can be any programmable electronic device or computing system capable of receiving and sending data, via network 106, and performing computer-readable program instructions known by those skilled in the art. In some exemplary embodiments, a compute node 110 can include a data storage repository (not shown) for storing data including, but not limited to, state information for all entities associated with an environment, transaction data, traffic segmentation table information, hash values, model allocation table information, and various models or policies. Data storage repository can be any programmable electronic device or computing system capable of receiving, storing, and sending files and data, and performing computer readable program instructions capable of communicating with driver 104, one or more clients 108, and traffic segmentation program 102, via network 106.

In some exemplary embodiments, driver 104 generates a traffic segmentation table and distributes a copy of the traffic segmentation table to the one or more compute nodes 110. In some exemplary embodiments, each compute node in the cluster retains a cached copy of the traffic segmentation table. In other exemplary embodiments, driver 104 distributes the traffic segmentation table to one or more compute nodes 110. In an exemplary embodiment, the traffic segmentation table can be packaged with all the other information needed to execute a task and distributed to the compute nodes. In some exemplary embodiments, the traffic segmentation table is a fixed size in which each entry in the table stores the identity of a model (e.g. “Model-A”, “Model-B”, “Model-C”, etc.). The number of entries in the table for each model determines the proportion of the traffic handled by that model.

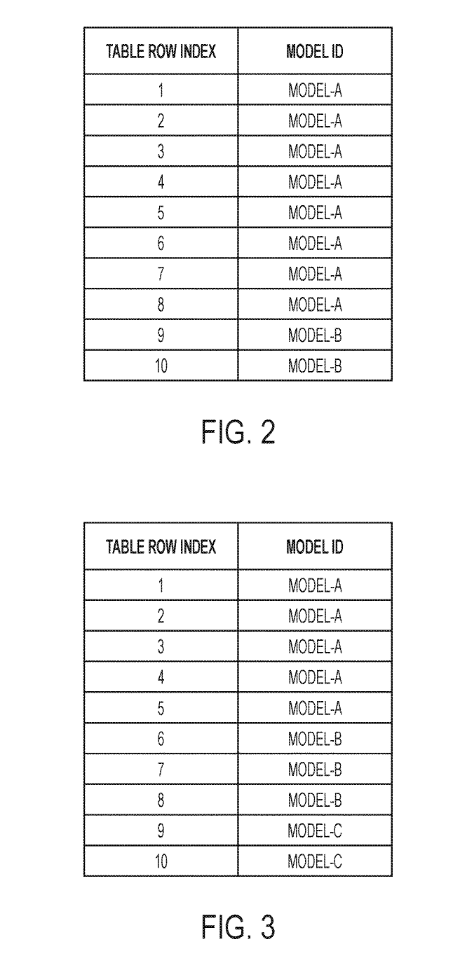

FIG. 2 is an example illustrating a traffic segmentation table, according to an exemplary embodiment. FIG. 2 illustrates an example of a traffic segmentation table with 10 rows, in which each row (i.e. a slot) represents 10% and the allocation of models to slots occurs in increments of 10%. Each row in the traffic segmentation table contains the identifier of a model. In this example, Slots 1 through 8 are assigned to “Model-A” and slots 9 and 10 are assigned to “Model-B”. Additionally, 80% of the slots are assigned to “Model-A” and 20% of the slots are assigned to “Model-B”. In an exemplary embodiment, the size of the traffic segmentation table determines the resolution of each slot. For example, a resolution of 1% can be achieved with a table size of 100, and resolution of 0.1% can be achieved with a table size of 1000.

In other exemplary embodiments, a traffic segmentation table contains more than two models. FIG. 3 is an example illustrating a traffic segmentation table with three models. In this example, slots 1-5 are assigned to Model-A (50%), slots 6-8 are assigned to Model-B (30%) and slots 9-10 are assigned to Model-C (20%). In an exemplary embodiment, the size of the traffic segmentation table determines the upper limit on the number of unique models that can be stored in the traffic segmentation table. For example, a table of size 10 can store up to 10 unique model IDs (i.e. identifiers), and a table of size 100 can store up to 100 unique model IDs. In some exemplary embodiments, the choice of the traffic segmentation table size may be based on the resolution and the maximum number of unique models to be compared with each other at any one time.

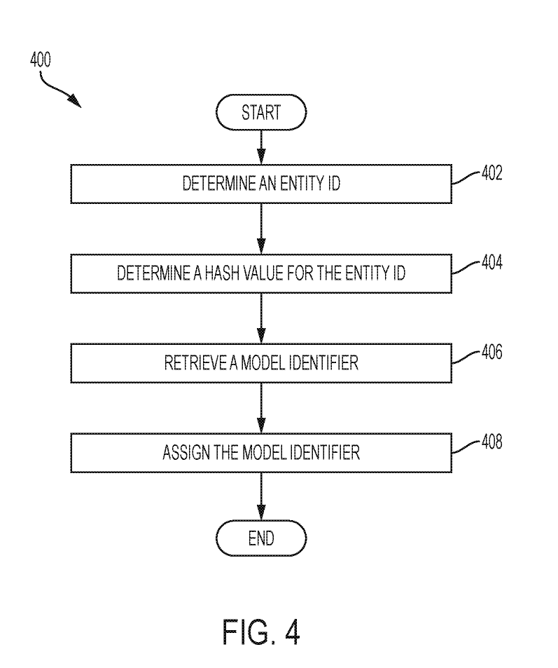

FIG. 4 is a flowchart illustrating the operational steps of traffic segmentation program 102, generally designated 400, to determine a model allocation for a request message, according to an exemplary embodiment. In some exemplary embodiments, one or more compute nodes 110 receive a request message from a client 108 via network 106. The request message from a client 108 may contain a unique identifier of the end user, customer, or entity. In an exemplary embodiment, the tasks, such as a provided service, running on one or more compute nodes 110 use the traffic segmentation table in order to assign a model to an entity.

Responsive to receiving a request message, traffic segmentation program 102 determines an entity ID (402). In an exemplary embodiment, traffic segmentation program 102, utilizing one or more compute nodes 110, determines an entity ID by extracting the entity ID, which uniquely identifies an end user, from the request message.

Traffic segmentation program 102 determines a hash value for the entity ID (404). In some exemplary embodiments, traffic segmentation program 102 determines a hash value for the entity ID by computing the hash value, in which the range is equal to the size of the traffic segmentation table.

Traffic segmentation program 102 retrieves a model identifier (406). In an exemplary embodiment, traffic segmentation program 102 indexes the hash value in the row index of traffic segmentation table and retrieves a model identifier from the indexed hash value.

Responsive to retrieving a model identifier, traffic segmentation program 102 assigns the model identifier (408). Traffic segmentation program assigns the model identifier, stored in the traffic segmentation table at the row index, to the request message.

In some exemplary embodiments, traffic segmentation program 102 stores the computed hash value for an entity ID in a lookup table or cache so subsequent requests with the same entity ID do not require computation of the hash value. In some exemplary embodiments, traffic segmentation program 102 associates the model with the model identifier assigned to the request message.

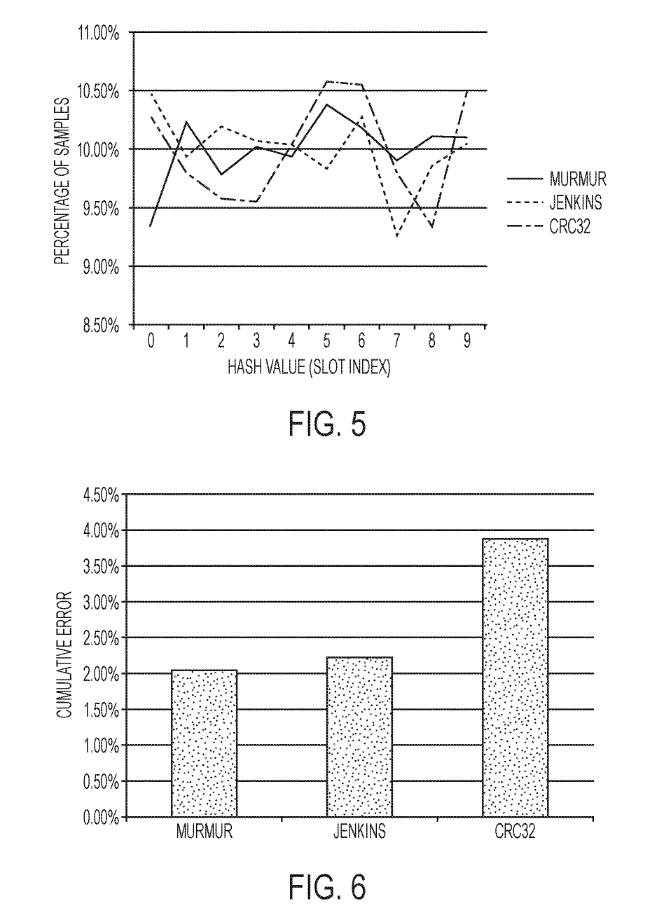

In other exemplary embodiments, traffic segmentation program 102 chooses a hash function so that the distribution of values for the set of entity IDs specific to the use case is uniform across the slots in the traffic segmentation table. Traffic segmentation program 102 may use multiple hash functions and combine the results if no prior information is available about the distribution of entity IDs. In an exemplary embodiment, if the type and distribution of entity IDs is known a priori, traffic segmentation program 102 chooses a hash function that is known to perform well for that use case. For example, traffic segmentation program 102 evaluates hash functions from a well-known set and picks the best hash function using a metric that measures how uniformly the samples are distributed across the slots in the table. The example in FIG. 5, discussed below, illustrates traffic segmentation program 102 selecting the hash function across hash values (i.e. slot indexes) when the distribution of entity IDs are known.

In FIG. 5, three hash functions (i.e. Murmur, Jenkins, and CRC32) known in the art are compared using an artificial data set made of 10,000 randomly generated phone numbers that correspond to the entity ID. Traffic segmentation program 102 assigns a percentage of samples to each slot in the table, assuming there are 10 slots. The percentage of samples assigned to each slot may be the same for all slots, which have a value of 10%. In order to compare the different hash functions, traffic segmentation program 102 computes a single metric for each hash function by quantifying the uniformity of the distribution of samples across the slots. For example, traffic segmentation program 102 computes the metric by determining the cumulative sum of the absolute deviation of the percentage of samples assigned to a slot compared to the ideal value. FIG. 6 is an example illustrating the comparison of the cumulative error for the three hash functions, according to an exemplary embodiment.

In FIG. 6, the Murmur hash function has the least cumulative error for this sample data set and would therefore be preferred over the other hash functions. In an exemplary embodiment, traffic segmentation program 102 can select the hash function automatically. Traffic segmentation program 102 can implement selecting the hash function automatically as a pre-deployment step in the in the distributed processing environment. In another exemplary embodiment, traffic segmentation program 102 can evaluate and select the best hash function any time after the system has been operational. For the cases in which traffic segmentation program 102 changes the hash function, traffic segmentation program 102 resets and rebuilds the traffic segmentation table.

In A/B testing, the choice of the hash function by traffic segmentation program 102 controls how the traffic is split across different models that are being tested. Traffic segmentation program 102 chooses the hash function that allocates the desired percentage of traffic to each of the models. When conducting of A/B testing, traffic segmentation program 102 dynamically changes the percentage of traffic allocated to the tested models. For example, traffic segmentation program 102 begins testing a small percentage of users allocated to Model-B, assuming that Model-A is the incumbent model in the production system and Model-B is a newly created model. The initial allocation of traffic to Model-B can be 10%. For the cases where there is evidence that Model-B is better than Model-A, traffic segmentation program 102 increases the percentage of traffic to Model-B to 20%. In another example, traffic segmentation program 102 introduces a third model, Model-C, and allocates 10% of the traffic to Model-C.

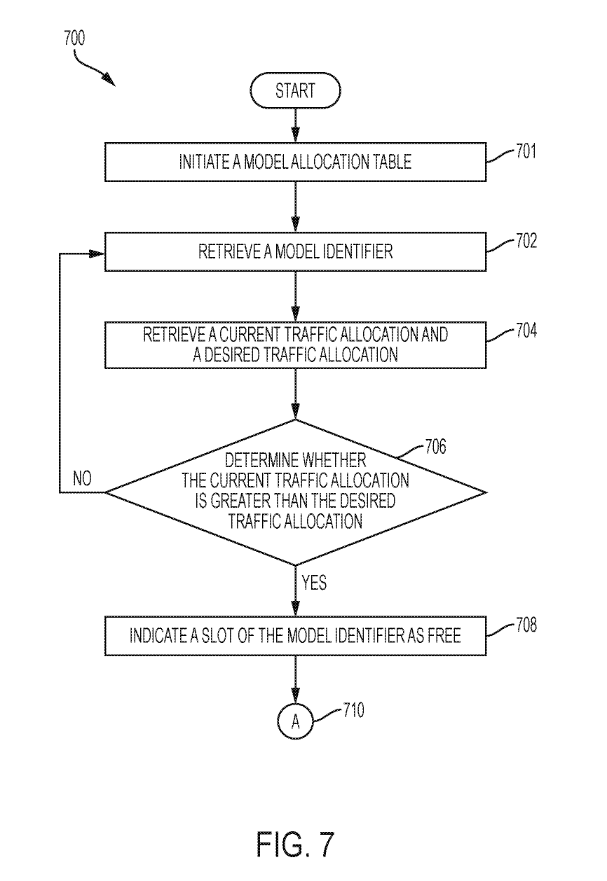

The method to dynamically change the Traffic Segmentation Table is described with reference to FIGS. 7 through 14, by way of examples. FIG. 7 is a flowchart illustrating the operational steps of traffic segmentation program 102, generally designated 700, to update the Traffic Segmentation Table, according to an exemplary embodiment. In some exemplary embodiments FIG. 7 illustrates the operational steps in the first stage of updating the Traffic Segmentation Table.

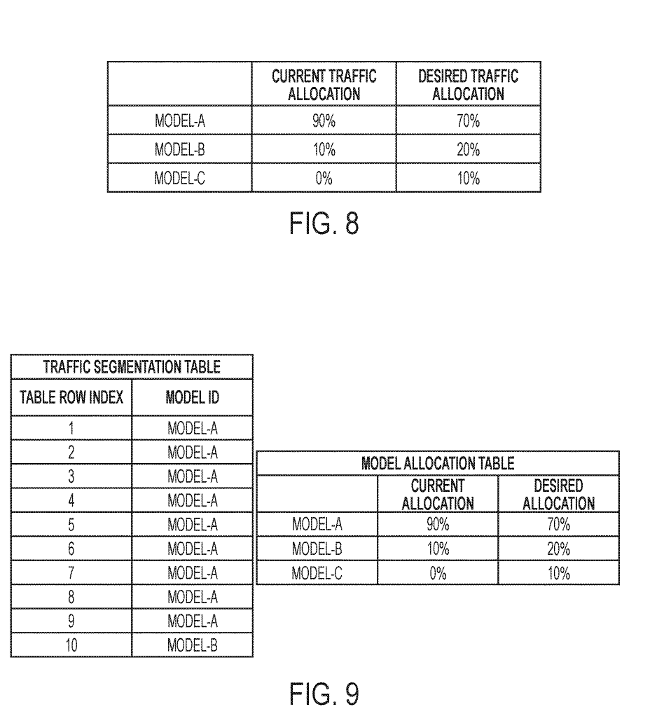

In some exemplary embodiments, Traffic segmentation program 102 updates the Traffic Segmentation Table in two stages. Traffic segmentation program 102 initiates a model allocation table (701). FIG. 8 is an example illustrating traffic segmentation program 102 initiating a Model Allocation Table, according to an exemplary embodiment. In an exemplary embodiment, traffic segmentation program 102 can initiate a model allocation table with one or more models. In some exemplary embodiments, traffic segmentation program 102 initiates a model allocation table by allocating a percentage of traffic to each model. For example, traffic segmentation program 102 initially allocates 90% of the traffic to Model-A and the remaining 10% of the traffic to Model-B. Traffic segmentation program 102 runs A/B testing for a period of time, in which the time period may be predetermined. When traffic segmentation program 102 observes Model-B performing satisfactorily, traffic segmentation program 102 introduces a new model, (e.g. Model-C). Responsive to introducing the new model, traffic segmentation program 102 changes the desired traffic allocation. For example, traffic segmentation program 102 allocates 70% of the traffic to Model-A, 20% of the traffic to Model-B, and 10% of the traffic to Model-C. Traffic segmentation program 102 captures the current and desired allocation of traffic to each model in the Model Allocation Table, as shown in FIG. 8.

In FIG. 8, each row in the Model Allocation Table corresponds to a specific model, and the columns indicate the current and desired traffic allocation for that specific model. For example, the first row in the Model Allocation Table corresponds to Model-A; the current traffic allocation for Model-A is 90%; and the desired traffic allocation for Model-A is 70%.

Responsive to initiating a model allocation table, traffic segmentation program 102 retrieves a model identifier (702). FIG. 9 is an example illustrating the initial states of the traffic segmentation and model allocation tables, according to an exemplary embodiment. In this example, the size of the traffic segmentation table is 10 and each row in the table represents 10% of the traffic. In some exemplary embodiments, traffic segmentation program 102 retrieves the model identifier (e.g. Model-A) stored in the row entry (e.g. Table Row Index 1) of the traffic segmentation table. Using the retrieved model identifier (e.g. Model-A) as the key, traffic segmentation program 102 retrieves a current traffic allocation (e.g. 90%) and a desired traffic allocation (e.g. 70%) from the model allocation table (704).

Traffic segmentation program 102, utilizing driver 104, determines whether the current traffic allocation is greater than the desired traffic allocation (decision block 706). If traffic segmentation program 102 determines the current traffic allocation for the model identifier is less than or equal to the desired traffic allocation (decision block 706, “NO” branch), traffic segmentation program 102 does not change the traffic segmentation table or model allocation table. Traffic segmentation program 102, utilizing driver 104, retrieves a model identifier of the next row in the traffic segmentation table and continues as described above.

For the cases in which traffic segmentation program 102 did determine the current traffic allocation for the model identifier is greater than the desired traffic allocation (decision block 706, “YES” branch), traffic segmentation program 102 indicates a slot of the model identifier as free (708). In some exemplary embodiments, traffic segmentation program 102, utilizing driver 104, marks the slot in the Traffic Segmentation Table as free (i.e. the model identifier is set to null or another indicator value). Traffic segmentation program 102 decrements the current traffic allocation for the model by the unit corresponding to each slot in the traffic segmentation table. For example, if each slot in the traffic segmentation table corresponds to 10% of the traffic, traffic segmentation program 102 decrements the current traffic allocation by 10%.

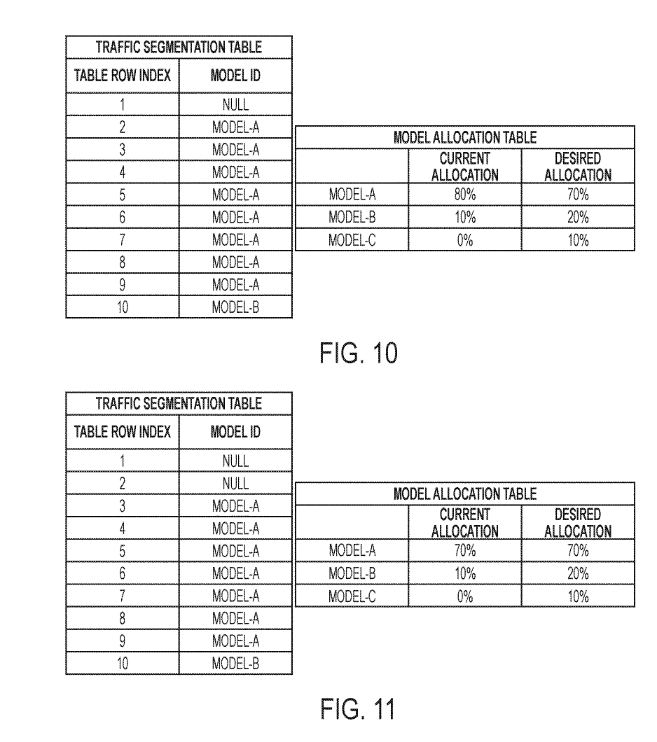

FIG. 10 is an example illustrating the states of the traffic segmentation table and model allocation tables after traffic segmentation program 102 processes the first row of the traffic segmentation table, according to an exemplary embodiment. In this example, traffic segmentation program 102 determines the current allocation for the model identifier is greater than the desired allocation for the model identifier. Traffic segmentation program 102 indicates the model identifier stored in the first row as “NULL,” and traffic segmentation program 102 decrements, by 10%, the current allocation for Mode-A to 80%.

Traffic segmentation program 102 ends the first stage when all rows in the traffic segmentation table are processed (710). FIG. 11 is an example illustrating the states of the traffic segmentation and model allocation tables after traffic segmentation program 102 processes all rows of the traffic segmentation table, according to an exemplary embodiment. In FIG. 11, traffic segmentation program 102 indicates the model identifiers stored in the first two rows of the traffic segmentation table as “NULL,” and traffic segmentation program 102 decremented the current traffic allocation for Model-A to the desired allocation value of 70%.

In some exemplary embodiments, at the end of the first stage of processing, the current traffic percentage allocated to any of the models may be less than or equal to the desired traffic percentage for that model. In some exemplary embodiments, traffic segmentation program 102 can process model identifiers where the traffic segmentation table is of arbitrary size. In other exemplary embodiments, the traffic percentage allocation of models can be any desired values that sum to 100%. In yet other exemplary embodiments, the free slots (i.e. the slots indicated as NULL) in the traffic segmentation table can be stored in a linked list, stack, a queue, or a storage repository known in the art.

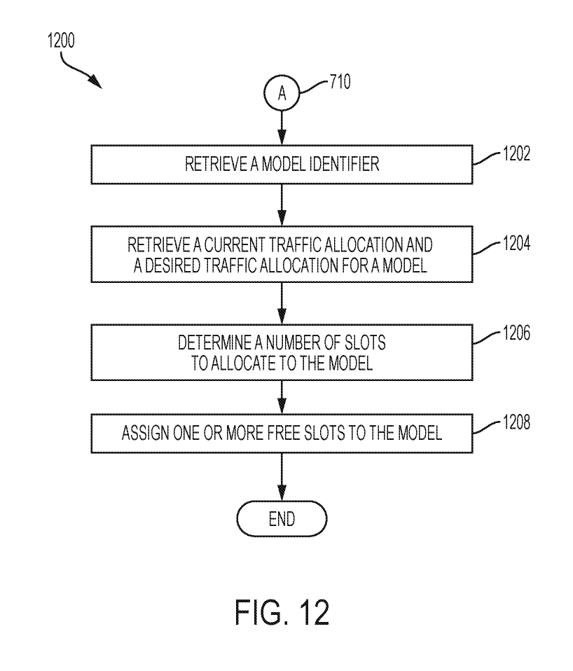

Responsive to the first stage ending, traffic segmentation program 102 proceeds to the second stage of updating the traffic segmentation table. FIG. 12 is a flowchart illustrating the operational steps of traffic segmentation program 102, generally designated 1200, to update the Traffic Segmentation Table, according to an exemplary embodiment. In an exemplary embodiment, traffic segmentation program 102 updates the Traffic Segmentation Table by allocating the slots, marked as free at the end of the first stage, to models whose current traffic percentage allocation is below the desired traffic allocation level. For example, in FIG. 11, traffic segmentation program 102 needs to increase the traffic percentage allocation for Model-B from 10% to 20%, and for Model-C from 0% to 10%.

Traffic segmentation program 102 retrieves a model identifier (1202). In an exemplary embodiment, traffic segmentation program 102 retrieves the model identifier from the model allocation table processed in the first stage. Traffic segmentation program 102 retrieves a current traffic allocation and a desired traffic allocation for the model (1204). For the cases in which the current traffic allocated to the model is equal to the desired traffic allocation, traffic segmentation program 102 does not take action on the row in the model allocation table and proceeds to the next row. For example, in FIG. 11, the first row of the Model Allocation Table corresponds to Model-A and the current and desired traffic allocation for this model both equal 70%, and traffic segmentation program 102 proceeds to process the next row.

For the cases (Model-B in FIG. 11) in which the current traffic allocated (e.g. 10%) to the model is less than the desired traffic allocation (e.g. 20%), traffic segmentation program 102 determines a number of slots to allocate to the model (1206). In some exemplary embodiments, traffic segmentation program 102 determines the number of slots to allocate to the model by computing the difference between the desired traffic allocation and current traffic allocation. Traffic segmentation program 102 uses the computed difference between the desired and current traffic allocation to determine the number of additional slots in the traffic segmentation table that need to be allocated to that model. For example, if the traffic segmentation table is of size 100, in which each slot represents 1% of the traffic, the number of additional slots needed is equal to the difference between the desired and current traffic allocations for that model. In another example, in FIG. 11, the second row in the model allocation table corresponds to Model-B. The current traffic allocation for Model-B is 10% and the desired traffic allocation is 20%. Traffic segmentation program 102 determines the current traffic allocation is less than the desired traffic allocation, and traffic segmentation program 102 determines the number of slots to allocate to Model-B is 10% or 1 slot.

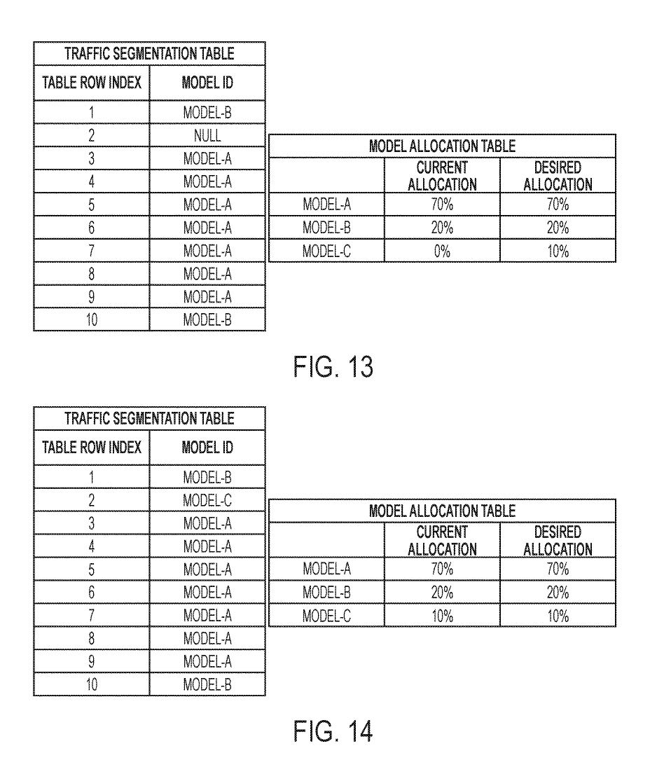

Having determined a number of slots to allocate to the model, traffic segmentation program 102 assigns one or more free slots to the model (1208). In some exemplary embodiments, traffic segmentation program 102 assigns one or more free slots by extracting the number of slots to allocate to the model from the free slots marked in the traffic segmentation table in the first stage. Traffic segmentation program 102 assigns the one or more extracted free slots to the model currently being processed. For example, in FIG. 13, the Traffic Segmentation Table is of size 10, in which each row of the table represents 10% of the traffic. Having determined 1 slot to allocate to Model-B, traffic segmentation program 102 extracts 1 free slot (e.g. slot 1 in row 1 marked “NULL” in FIG. 11) from the traffic segmentation table. Traffic segmentation program 102 assigns the extracted free slot to Model-B as shown in FIG. 13.

In another example, illustrated in FIG. 14, when traffic segmentation program 102 processes the second row of the model allocation table, traffic segmentation program 102 processes the third and last row of the model allocation table. The third row in the model allocation table corresponds to Model-C. The current traffic allocation for Model-C is 0% and the desired traffic allocation is 10%. Similar to the case of Model-B in the second row, the additional traffic allocation desired for Model-C is 10%. Traffic segmentation program 102 extracts the next free slot (e.g. row 2 in FIG. 13) of the traffic segmentation table and assigns the free slot to Model-C. With this assignment, the current traffic allocation to Model-C reaches the desired goal of 10%. Having processed the rows in the model allocation table, traffic segmentation program 102 completes updating the traffic segmentation table and ends. In an exemplary embodiment, traffic segmentation program 102 can process the rows in the model allocation table when the number of rows in the model allocation table is arbitrary. In another exemplary embodiment, traffic segmentation program 102 sends the updated traffic segmentation table to the one or more compute nodes 110 to process user traffic from one or more clients 108.

Although the subject matter has been described in terms of exemplary embodiments, it is not limited thereto. Rather, the appended claims should be construed broadly, to include other variants and embodiments, which may be made by those skilled in the art without departing from the scope and range of equivalents of the subject matter.

What is claimed is:

1. A dynamically segmenting traffic method, implemented by one or more processors, the method comprising:
initiating a model allocation table by allocating traffic to one or more models;
retrieving a model identifier from a traffic segmentation table;
retrieving a current traffic allocation and a desired traffic allocation for the model identifier;
indicating a slot of the model identifier as free in the traffic segmentation table;
determining a number of slots to allocate to the model; and
assigning one or more free slots to the model.

2. The method of claim 1 further comprising:
responsive to receiving a request message, determining an entity identifier, wherein the entity identifier is extracted from the request message;
determining a hash value for the entity identifier;
retrieving the model identifier from the hash value; and
assigning the model identifier to the request message.

3. The method of claim 2 wherein determining a hash value for the entity identifier further comprises:
computing the hash value with a range being equal to the size of the traffic segmentation table; and
indexing the hash value into the traffic segmentation table.

4. The method of claim 1 further comprising:
determining the current traffic allocation for the model identifier is less than or equal to the desired traffic allocation, wherein the traffic segmentation table and model allocation table remain unchanged; and
retrieving a model identifier in a subsequent slot of the traffic segmentation table.

5. The method of claim 1 wherein indicating the slot of the model identifier as free further comprises:
determining the current traffic allocation for the model identifier is greater than the desired traffic allocation; and
decrementing the current traffic allocation for the model by a unit corresponding to each slot in the traffic segmentation table.

6. The method of claim 1 wherein determining the number of slots to allocate to the model further comprises:
determining the current traffic allocated to the model is less than the desired traffic allocation; and
computing the difference between the desired traffic allocation and the current traffic allocation.

7. The method of claim 1 wherein assigning one or more free slots to the model further comprises:
extracting the number of slots to allocate to the model from the slots indicated as free in the traffic segmentation table.

8. A traffic segmenting apparatus, the apparatus comprising:
at least one memory operable to store program instructions;
at least one processor operable to read the stored program instructions; and
according to the stored program instructions, the at least one processor is configured to be operated as:
a driver configured to initiate a model allocation table by allocating traffic to one or more models, to retrieve a current traffic allocation and a desired traffic allocation for the model identifier, to indicate a slot of the model identifier as free in the traffic segmentation table, to determine a number of slots to allocate to the model, and to assign one or more free slots to the model; and
one or more compute nodes configured to retrieve a model identifier from a traffic segmentation table.

9. The apparatus of claim 8 wherein the one or more compute nodes are further configured to determine an entity identifier, wherein the entity identifier is extracted from a request message, to determine a hash value for the entity identifier, to retrieve the model identifier from the hash value, and to assign the model identifier to the request message.

10. The apparatus of claim 9 wherein the one or more compute nodes, being configured to determine the hash value for the entity identifier, are further configured to compute the hash value with a range being equal to the size of the traffic segmentation table; and to index the hash value into the traffic segmentation table.

11. The apparatus of claim 8 wherein the driver is further configured to determine the current traffic allocation for the model identifier is less than or equal to the desired traffic allocation, wherein the traffic segmentation table and model allocation table remain unchanged;
and wherein the driver is further configured to retrieve a model identifier in a subsequent slot of the traffic segmentation table.

12. The apparatus of claim 8 wherein the driver, being configured to indicate the slot of the model identifier as free, is further configured:
to determine the current traffic allocation for the model identifier is greater than the desired traffic allocation; and
to decrement the current traffic allocation for the model by a unit corresponding to each slot in the traffic segmentation table.

13. The apparatus of claim 8 wherein the driver, being configured to determine the number of slots to allocate to the model, is further configured:
to determine the current traffic allocated to the model is less than the desired traffic allocation; and
to compute the difference between the desired traffic allocation and the current traffic allocation.

14. The apparatus of claim 8 wherein the driver, being configured to assign one or more free slots to the model, is further configured:
to extract the number of slots to allocate to the model from the slots indicated as free in the traffic segmentation table.

15. A non-transitory computer readable storage medium, implemented by one or more processors, storing traffic segmentation program for causing a computer to function as:
a driver configured to initiate a model allocation table by allocating traffic to one or more models, to retrieve a current traffic allocation and a desired traffic allocation for the model identifier, to indicate a slot of the model identifier as free in the traffic segmentation table, to determine a number of slots to allocate to the model, and to assign one or more free slots to the model; and
one or more compute nodes configured to retrieve a model identifier from a traffic segmentation table.

16. The non-transitory computer readable storage medium of claim 15, wherein the one or more compute nodes are further configured to determine an entity identifier, wherein the entity identifier is extracted from a request message, to determine a hash value for the entity identifier, to retrieve the model identifier from the hash value, and to assign the model identifier to the request message.

17. The non-transitory computer readable storage medium of claim 16, wherein the one or more compute nodes, being configured to determine the hash value for the entity identifier, are further configured to compute the hash value with a range being equal to the size of the traffic segmentation table; and to index the hash value into the traffic segmentation table.

18. The non-transitory computer readable storage medium of claim 15, wherein the driver is further configured to determine the current traffic allocation for the model identifier is less than or equal to the desired traffic allocation, wherein the traffic segmentation table and model allocation table remain unchanged; and wherein the driver is further configured to retrieve a model identifier in a subsequent slot of the traffic segmentation table.

19. The non-transitory computer readable storage medium of claim 15, wherein the driver, being configured to indicate the slot of the model identifier as free, is further configured:
to determine the current traffic allocation for the model identifier is greater than the desired traffic allocation; and
to decrement the current traffic allocation for the model by a unit corresponding to each slot in the traffic segmentation table.

20. The non-transitory computer readable storage medium of claim 15, wherein the driver, being configured to determine the number of slots to allocate to the model, is further configured:
to determine the current traffic allocated to the model is less than the desired traffic allocation; and
to compute the difference between the desired traffic allocation and the current traffic allocation.
